(19) United States
(12) Patent Application Publication
(10) Pub. No.: US 2010/0163581 A1
(43) Pub. Date: Jul. 1, 2010

(54) FLUID DISPENSING APPLIANCE AND CORRESPONDING METHOD OF MANUFACTURE

(75) Inventor: Michel Maurice Camille Vandromme, Le Plessis Brion (FR)

Correspondence Address: BARNES & THORNBURG LLP, Suite 1150, 3343 Peachtree Road, N.E., Atlanta, GA, 30326-1428, US

(73) Assignee: YVES SAINT LAURENT PARFUMS, Neuilly sur Seine (FR)

(21) Appl. No.: 12/160,668

(22) PCT Filed: Jan. 12, 2007
(86) PCT No.: PCT/FR07/00058

§ 371 Date: Mar. 12, 2010

(30) Foreign Application Priority Data
Jan. 12, 2006 (FR) 0600295

(51) Int. Cl. B65D 37/00; B23P 17/04; B65D 35/28

(52) U.S. Cl. 222/214; 29/428; 222/103

(57) ABSTRACT

A cosmetic fluid dispensing apparatus (1) comprising a bottle (2) for containing the cosmetic fluid to be dispensed, the bottle (2) being deformable when compressed from a rest configuration in which the bottle (2) has a predetermined capacity to at least one deformed configuration in which the bottle (2) has a smaller capacity than the predetermined capacity, the bottle (2) having a shape memory in order to revert to its rest configuration, the bottle (2) being disposed between two flaps (3, 4) separate from the bottle (2), the flaps (3, 4) are brought together by a closing force in order to give the bottle its deformed configuration, and the assembly formed by the flaps (3, 4) having a shape memory so as to revert to a configuration in which the compression by the flaps (3, 4) is removed.

### PRIORITY CLAIM

This patent application is a U.S. National Phase of International Patent Application No. PCT/FR2007/000058, filed Jan. 12, 2007, which claims priority to French Patent Application No. 0600295, filed Jan. 12, 2006, the disclosures of which are incorporated herein by reference in their entirety.

### FIELD

The present disclosure relates to cosmetics and, in particular, to cosmetic fluid dispenser devices, such as perfume sample sprays.

The present disclosure relates more particularly to a cosmetic fluid dispenser device comprising, in one exemplary embodiment, a flask for containing the cosmetic fluid for dispensing, the flask being deformable so as to pass, on being compressed, from a rest configuration in which the flask presents a predetermined capacity to at least one deformed configuration in which the flask presents a capacity that is smaller than the predetermined capacity, the flask presenting shape memory capable, when not compressed, of returning on its own from its deformed configuration to its rest configuration.

The present disclosure also relates to a method of fabricating a cosmetic fluid dispenser device, the method comprising, in one exemplary embodiment, a step of providing or fabricating a flask for containing the cosmetic fluid for dispensing, in which step a flask is fabricated or provided that is suitable for passing, on being compressed, from a rest configuration in which the flask presents a predetermined capacity to at least one deformed configuration in which the flask presents a capacity that is less than the predetermined capacity, the flask presenting shape memory capable, when not compressed, of returning on its own from its deformed configuration to its rest configuration.

### BACKGROUND

In the field of perfumery it is known to make use of small rigid bottles for containing perfume samples, i.e., perfumes in a small quantity (e.g., in the range of 0.2 milliliters (mL) to 3 mL), which is the amount that is necessary and sufficient to enable a potential client to try the perfume. Such bottles are generally tubular in shape and are provided with a top opening that can be closed either with a removable stopper or with a sprayer endpiece.

Nevertheless, because of their small size and the nature of the materials used for fabricating them (generally glass), those sample bottles are poorly adapted to being marked with advertising.

However, such a bottle is above all an article for use in promoting sales, so it is of very great importance to ensure that potential clients can identify at a glance at least the name of the perfume contained in the bottle and also the name of the supplier. It is also generally necessary, depending on the health regulations that are in force, to provide the user of such a perfume sample with a certain amount of information relating to the composition of the perfume and relating to traceability in its fabrication.

In order to satisfy all of the above-mentioned requirements, it is known to associate each sample bottle with a presentation card made by folding a printed sheet of card. Such a card generally presents a U-shaped profile, with a spine that corresponds to the web of the U-shape, and with two flaps that correspond respectively to the two limbs of the U-shape. The bottle is secured to the spine of the card between the flaps. The card thus provides a relatively large visible area suitable for receiving, by any known print means, all of the above-mentioned commercial and/or regulatory information. Although such a technical solution is generally satisfactory, it nevertheless suffers from a certain number of drawbacks.

First, a bottle associated with a card turns out to be rather awkward for the user to use. Prior to applying the perfume proper, the user must first separate the bottle from the card. Apart from being awkward, this operation of separating the bottle can be quite difficult to perform and can sometimes even lead to the card being accidentally torn.

Second, such difficulty in handling is particularly unwelcome since it relates to an article destined for advertising and promotional use, i.e., an article that is intended to convey a prestigious image of a perfume and of its manufacturer.

Third, once the operation of separating the bottle from the card has been accomplished, the user must then proceed with an operation of applying the perfume. When the bottle has a simple stopper, the user needs to remove the stopper in order to pour a small quantity of perfume onto the skin, or to rub the perfume-soaked stopper on the skin. Such an operation is once more both awkward and difficult, since the stoppers on bottles of known type are generally small in size and securely plugged into the opening of the bottle. It is, therefore, not unusual for some of the perfume contained in the bottle to be spilt accidentally on opening the bottle, which is inconvenient to say the least.

Fourth, when the bottle is fitted with a spray, its small size and its cylindrical shape can sometimes make it difficult for the user to perceive the spray orifice and the direction in which the orifice points. This can lead to the perfume being sprayed in an inappropriate direction. Above all, handling such a spray is often awkward, given the small size of the bottle and thus the lack of grip it provides in handling.

Fifth, fabricating such a sample device comprising a card and a bottle is relatively lengthy and complex since it requires a large number of operations, and worse, it often requires operations that involve different techniques, i.e.: shaping operations (cutting, folding) and printing operations on the card; separately fabricating the bottle and the stopper or the spray endpiece for fitting thereto; filling the bottle and closing it with the stopper or the spray endpiece; and fastening the bottle to the card.

Such complexity in construction naturally increases the cost of such prior art devices, in particular, when using a bottle with a spray endpiece since the spray usually implements a miniature pump system of non-negligible expense. However, it is particularly important to control the cost of such devices since they are for giving away at no cost to the recipient.

Finally, associating two elements that are as different as a card made of cardboard or strong paper and a bottle made of glass can be considered as contributing unfavorably in terms of appearance to the general perception of the sample.

### SUMMARY

The present disclosure describes several exemplary embodiments of the present invention.

One aspect of the present disclosure provides a cosmetic fluid dispenser device, comprising a) a flask for containing the cosmetic fluid for dispensing, said flask being deformable so as to pass, on being compressed, from a rest configuration in which said flask presents a predetermined capacity to at least one deformed configuration in which said flask presents a capacity that is smaller than said predetermined capacity, said flask presenting shape memory so as to be capable, when not compressed, of returning on its own from its deformed configuration to its rest configuration; and b) two flaps distinct from said flask and between which said flask is disposed, said flaps being designed to be capable of being moved towards each other under the effect of a force exerted by a user so as to compress said flask in order to bring said flask to its deformed configuration, the assembly constituted by said flaps also presenting shape memory so that when the force ceases to be applied said flask returns on its own to a configuration in which said flaps are spaced far enough apart to no longer compress said flask.

Another aspect of the present disclosure provides a method of fabricating a cosmetic fluid dispenser device, comprising i) providing a flask for containing the cosmetic fluid for dispensing, in which a flask is fabricated or provided that is suitable for passing, on being compressed, from a rest configuration in which said flask presents a predetermined capacity, to at least one deformed configuration in which said flask presents a capacity that is less than said predetermined capacity, said flask presenting shape memory so as to be capable, when not compressed, of returning on its own from its deformed configuration to its rest configuration; ii) providing two connected flaps that are distinct from said flask; and iii) placing said flask between said flaps, said flaps being designed to be movable towards each other under the effect of a user exerting a force to compress said flask so as to bring said flask into its deformed configuration, the assembly formed by said flaps also presenting shape memory so as to be capable, when the force ceases to be applied, of returning on its own to a configuration in which said flaps are spaced far enough apart to no longer compress said flask.

Consequently, the present disclosure seeks to provide a remedy to the various drawbacks mentioned above, and to provide a novel cosmetic fluid dispenser device that is simple to use, has a low cost of manufacture, is particularly reliable in operation, and leads to new presentation options that are particularly attractive.

Another feature of the present disclosure provides a cosmetic fluid dispenser device that is particularly simple and reliable in construction.

Another feature of the present disclosure provides a cosmetic fluid dispenser device made from a small number of parts.

A further feature of the present disclosure provides a novel cosmetic fluid dispenser device capable of standing stably on a support while optimizing viewing of the identification or advertising information with which the device can be covered.

An additional feature of the present disclosure provides a cosmetic fluid dispenser device having a greatly simplified design.

Another feature of the present disclosure provides a cosmetic fluid dispenser device made by a very simple mechanical assembly of a minimum number of parts.

A further feature of the present disclosure provides a method of fabricating a cosmetic fluid dispenser device that is particularly simple and quick to implement.

An additional feature of the present disclosure provides a method of fabricating a cosmetic fluid dispenser device making use of a minimum number of steps of different kinds.

Another feature of the present disclosure provides a method of fabricating a cosmetic fluid dispenser device essentially based on particularly simple mechanical assembly operations that are inexpensive to perform.

### BRIEF DESCRIPTION OF THE DRAWINGS

Other features and advantages of the present disclosure appear in greater detail on reading the following description and the accompanying drawings given by way of non-limiting explanation, in which:

FIG. 1 is a perspective view of a cosmetic fluid dispenser device in accordance with one exemplary embodiment of the present disclosure;

FIG. 2 is a face view showing a cosmetic fluid dispenser device constituting a first exemplary embodiment of the present disclosure;

FIG. 3 is a section view on line C-C of the device shown in FIG. 2;

FIG. 4 is a section view on line A-A of the device shown in FIGS. 2 and 3;

FIG. 5 is a view similar to FIG. 4 showing a cosmetic fluid dispenser device constituting a second exemplary embodiment of the present disclosure;

FIG. 6 is a side view of a one-piece V-shaped body constituting the device shown in FIG. 5; and

FIG. 7 is a perspective view showing the flask of the devices shown in FIGS. 1-5.

### DETAILED DESCRIPTION

FIG. 1 shows a cosmetic fluid dispenser device 1 in accordance with one exemplary embodiment of the present disclosure. Below, reference is made more particularly to a cosmetic fluid dispenser device 1 for propelling a cosmetic that is liquid. More particularly, reference is made to a device 1 constituting a fragrance spray, and even more preferably to a device 1 constituting a spray for a sample of perfume, i.e., a mini-spray that is preferably not refillable and that is designed to be given away to potential future clients in order to enable them to try out a given perfume.

Nevertheless, the present invention is not limited to this preferred exemplary application. Thus, the device of the present disclosure is independent of the way in which the cosmetic fluid is propelled, whether the propulsion consists in spraying, as in the preferred example shown in the figures, or merely in expelling the fluid. The device of the present disclosure is also independent of the type of cosmetic fluid to be dispensed and, in particular, is independent of the consistency and the viscosity of the fluid in question. The fluid may thus be constituted by a perfume, as in the preferred application shown in the figures, but also, as an alternative, by a cream or even a powder. The term “cosmetic fluid” as used herein is understood to designate any cosmetic substance in liquid, semiliquid, pasty, or powder form that is capable of presenting the ability to flow.

The device 1 in accordance with the present disclosure preferably constitutes a device that is suitable for being held and operated by hand.

In accordance with the present disclosure, the cosmetic fluid dispenser device 1 includes a flask 2 that is designed to contain the cosmetic fluid for dispensing. The flask 2 thus forms a reservoir capable of receiving and storing the cosmetic fluid for dispensing. The flask 2 is preferably designed to store a perfume. In the example shown in the figures, the flask 2 is substantially pear-shaped, it being understood that the present invention is not limited in any way to some particular shape for the flask.

In accordance with the present disclosure, the flask 2 is deformable so as to be capable of passing, on being compressed, from a rest configuration, as shown in the figures, and in which the flask 2 presents a predetermined capacity, to at least one deformed configuration (not shown), in which the flask 2 presents capacity that is smaller than the predetermined capacity. In other words, the flask 2 is of a flexible nature such that when the flask 2 is subjected to mechanical compression stress, e.g., by being squeezed, flattened, and/or pinched, the flask 2 deforms and decreases in volume thereby reducing its capacity.

For this purpose, the flask 2 preferably comprises a flexible bulb 2A forming a pouch that contains the fluid for dispensing, the flexible bulb 2A being of a flexible and deformable nature such that the pouch it defines presents a volume that is variable. Preferably, the bulb 2A presents a shape that is substantially a surface of revolution about an axis of symmetry X-X′.

In an exemplary embodiment, the capacity of the flask 2 is directly a function of the amount of the applied stress and deformation. In this preferred example, the flask 2 can pass from its rest configuration to a plurality of distinct deformed configurations, each deformed configuration corresponding to a specific capacity.

Preferably, the predetermined capacity is determined by construction and corresponds to the capacity of the flask 2 when the flask is subjected to substantially no mechanical stress, naturally ignoring the stresses that are inherent to the flask 2 being mounted and held within the device 1. Advantageously, the predetermined capacity of the flask 2 in the rest configuration is dimensioned so as to enable the flask 2 to store a sample of perfume. For this purpose, the capacity of the flask 2 preferably lies in the range of 0.1 mL to 5 mL, and even more preferably in the range of 0.2 mL to 2 mL. For example, the predetermined capacity may be 0.5 mL or 1.5 mL. Nevertheless, the present disclosure is not limited to dispensing a sample and the capacity of the flask 2 may be quite clearly greater than the above-mentioned values, for example, it may be about 10 mL.

In accordance with the present disclosure, the flask 2 presents shape memory thus enabling the flask, when not compressed, to return on its own from its deformed configuration back to its rest configuration. In other words, the rest configuration of the flask 2 is likewise a return configuration into which the flask 2 returns automatically merely by its own intrinsic properties on the disappearance of the mechanical stress that led to the deformed configuration.

The flask 2 and, more particularly, the bulb 2A, is thus elastically deformable, i.e., the flask is capable of returning to the rest configuration elastically from its deformed configuration.

The flask 2 may be made of any material known to the person skilled in the art and that enables the shape memory effect specified by the present disclosure to be obtained. Preferably, the flask 2, or indeed its storage-performing portion, i.e., the bulb 2A, is made of a plastic material (such as polypropylene), which is formed, for example, by molding or by blow-extrusion.

Advantageously, and as can be seen in particular in FIG. 7, the flask 2 comprises both the bulb 2A defining an internal volume for storing cosmetic fluid that is to be dispensed and also a fluid-expulsion opening 2B formed in and through the bulb 2A. The expulsion opening 2B is thus an orifice enabling the inside of the flask 2 to be put into communication with the outside. When the flask 2 passes from its rest configuration shown in FIG. 7 to its deformed configuration (not shown), e.g., under the effect of the bulb 2A being pinched, that causes a fraction of the cosmetic fluid contained in the flask 2 to be propelled through the expulsion opening 2B together with a fraction of the air that is also contained in the flask 2. When the mechanical stress exerted on the bulb 2A ceases, the flask 2 itself returns automatically into its rest configuration which can lead to air being sucked in through the expulsion opening 2B from the outside to the inside of the flask 2A. Preferably, and as shown in FIG. 7, the flask 2 is provided with an assembly tab 2C spreading from the expulsion opening 2B. More precisely, the assembly tab 2C is substantially plane and rectangular in shape, extending substantially in the same plane as that in which the expulsion opening 2B of the flask 2 extends. Preferably, the expulsion opening 2B is substantially symmetrical about the axis X-X′. The assembly tab 2C thus preferably extends substantially perpendicularly to the axis X-X′. As shown in FIG. 7, the expulsion opening 2B is advantageously positioned substantially in the center of the tab 2C such that the tab forms two lugs projecting symmetrically in opposite directions from the expulsion opening 2B. The function required of the tab 2C is explained in greater detail below. Preferably, the tab 2C and the bulb 2A are made integrally, such that the flask 2 forms a single-piece unit, e.g., obtained by a single operation of molding or of blow-extruding polypropylene.

In accordance with the present disclosure, the device 1 also comprises two flaps, specifically first and second flaps 3, 4 with the flask 2 being placed between them. In other words, the flask 2 is interposed between the flaps 3, 4 in the interstitial space that extends between the flaps 3, 4.

As shown in the figures, the flask 2 is separate both from the first flap 3 and from the second flap 4. In other words, the flask 2 is advantageously completely independent of the flaps 3, 4, i.e., neither flap contributes to forming the flask 2. Thus, the flaps 3, 4 are distinct from the flask 2, i.e., the flaps do not form portions of the flask 2 and, therefore, do not contribute directly to defining the capacity of flask 2.

In accordance with the present disclosure, the first and second flaps 3, 4 are designed to be moved towards each other by the user of the device 1 exerting a force thereon (preferably by hand and directly) so as to compress the flask 2 (by pressing the flask between the flaps) so as to bring the flask into the deformed configuration. In other words, the first and second flaps 3, 4 are mounted to be movable, at least locally, relative to each other so as to be capable of being moved towards each other, this movement causing the flask 2 to be compressed by the flaps 3, 4 so that the flask 2 passes from its rest configuration to its deformed configuration. The flaps 3, 4 preferably perform two functions. Firstly, the flaps 3, 4 serve to compress the flask 2; and, secondly, the flaps 3, 4 constitute support surfaces suitable for receiving marking on the device 1.

The flaps 3, 4 thus enable the device 1 to be given a large marking area that can be seen clearly by the user. The flaps 3, 4 also make it easier to hold the device 1 and to actuate the device 1.

The assembly formed by the flaps 3, 4 also presents shape memory so as to be capable, when the user-applied force ceases to be applied, of returning on its own to a configuration such that the flaps 3, 4 are spaced far enough apart to no longer compress the flask 2, thereby enabling the flask to return to its rest configuration by virtue of its own shape memory. In other words, the flaps 3, 4 are designed to return on their own and independently of the shape memory of the flask 2 to a configuration in which the flaps 3, 4 are spaced apart to a maximum extent, and to do so as soon as the user ceases to exert a force tending to urge the flaps 3, 4 towards each other.

The present disclosure thus relies on implementing two elements, each of which presents its own shape memory in independent manner, i.e., the flask 2 and also the assembly constituted by the flaps 3, 4. Because the assembly constituted by the flaps 3, 4 presents its own shape memory, the flaps 3, 4 do not hinder, and on the contrary tend to encourage, return of the flask 2 to its rest configuration. This makes it possible to use a flask 2 that is very flexible, presenting shape memory but not very strongly. Nevertheless, because the flask 2 and the flaps 3, 4 constitute parts that are distinct and independent, the device 1 is particularly simple and inexpensive to assemble and construct.

Advantageously, as shown in the figures, the first and second flaps 3, 4 are attached to each other, i.e., they are mechanically connected together. Preferably, the first and second flaps 3, 4 are attached to each other via a link part 5. In other words, the device 1 includes a link part 5 that is attached both to the first flap 3 and to the second flap 4. The link part 5 thus provides the junction between the flaps 3, 4.

The link part 5 is preferably distinct from and independent of the flask 2. Nevertheless, it is entirely possible to envisage that the link part 5 could be formed directly by the flask 2 itself.

Advantageously, the link part 5 and the flaps 3, 4 are arranged substantially in a V-shape, each flap 3, 4 forming a respective one of the two limbs of the V-shape, while the link part 5 forms the tip of the V-shape, i.e., the junction zone for the limbs of the V-shape. Preferably, and as shown in the figures, each flap 3, 4 is in the form of a substantially plane rectangular flap, the flaps 3, 4 being identical. The link part 5 preferably presents a curved outline so as to provide a smooth connection between the first flap 3 and the second flap 4.

Thus, each of the flaps 3, 4 extends between a first end 3A, 4A that is secured to the link part 5, and a second end 3B, 4B that is free. Advantageously, these free ends 3B, 4B act as a base for the device 1, i.e., free ends 3B, 4B form a stand enabling the device 1 to be stood up in stable manner on a support plane.

Above, the flaps 3, 4 are described as being disposed in a V-configuration, i.e., the flaps 3, 4 form between them an angle a that is less than 180°. Nevertheless, it is entirely possible to envisage the first and second flaps 3, 4 being disposed in a different arrangement, e.g., extending substantially parallel to each other.

Advantageously, each flap 3, 4 is hinged resiliently to the link part 5. In other words, the junction between the link part 5 and the first ends 3A, 4A respectively of the first and second flaps 3, 4 takes place via flexible connections that present resilient return. Under such circumstances, the flaps 3, 4 can be moved towards each other by exerting a force on each flap towards the other flap, which force causes the flaps 3, 4 to pivot relative to the link part 5, with the pivoting decreasing the angle a formed between the flaps 3, 4. The flaps 3, 4 are thus preferably designed to be moved towards each other by the flaps 3, 4 pivoting relative to the link part 5. In other words, in the exemplary embodiment shown in the figures, moving the flaps 3, 4 towards each other corresponds to reducing the spread angle between the flaps 3, 4. Under such circumstances, it is preferable for the flaps 3, 4 to be of a substantially rigid nature. Nevertheless, it is entirely possible to envisage the flaps presenting a relatively flexible and deformable nature, such that the flaps 3, 4 are moved towards each other not by changing the relative angle between the flaps 3, 4, but by local elastic deformation of the flaps 3, 4 towards each other.

Because of the resilient nature of the connection between the flaps 3, 4 and the link part 5, the flaps 3, 4 are suitable, when urged towards each other, for passing from a maximum-spread configuration (shown in the figures) in which the flaps 3, 4 are spread apart from each other by a determined distance (i.e., in the variant shown in the figures, they form a predetermined angle between each other), to at least one configuration of smaller spread, in which the flaps 3, 4 are spaced apart by a predetermined distance (i.e., for the variants shown in the figures, the flaps 3, 4 form between them an angle that is smaller than the predetermined angle), the flaps 3, 4 being urged to return towards the maximum-spread configuration from the configuration of reduced spread when the force urging them towards each other disappears.

Thus, the assembly formed by the link part 5 and the flaps 3, 4 advantageously presents shape memory independently of the flask 2, i.e., the flaps can be moved towards each other by applying mechanical stress thereto and the flaps are suitable for returning elastically and automatically to their maximum-spread configuration when the mechanical stress ceases. Naturally, implementing shape memory that is obtained by elastically deforming the hinge connections between the flaps 3, 4 and the link part 5 is purely optional; and it is entirely possible to envisage the flaps 3, 4 being mounted merely to pivot freely relative to the link part 5 without any resilient return effect. Under such circumstances, the flaps 3, 4 can be caused to return to the maximum-spread configuration from their reduced-spread configuration under the effect of a driving force exerted by an external element, such as a return spring.

Advantageously, the flaps 3, 4 and the link part 5 form portions of a single one-piece body 6. In other words, the flaps 3, 4 and the link part 5 form an independent unitary part. Preferably, the flaps 3, 4 are made integrally with the link part 5. Under such circumstances, it is possible for the one-piece body 6 to be made by molding a plastics material, and preferably by molding polyoxymethylene (POM or polyacetal). The body 6 thus forms an elastically deformable body enabling the flaps 3, 4 to be moved towards each other and enabling them to spread apart automatically by resilient return when the force urging the flaps 3, 4 towards each other disappears. In other words, the body 6 forms a one-piece squeezer with jaws formed by the flaps 3, 4 and with the jaws encompassing the flask 2.

In a preferred exemplary embodiment, the present invention thus consists of a device 1 comprising two independent one-piece unitary parts that are constituted respectively by the flask 2 and by the body 6, the parts being assembled together.

The flaps 3, 4 are preferably moved towards each other manually by the user, e.g., using the fingers of one hand. Nevertheless, it is entirely possible to envisage them being moved towards each other by any other means known to the person skilled in the art, for example, by using mechanical means.

Advantageously, the device 1 includes a dispenser orifice 7 formed in and through the link part 5 and functionally connected to the flask 2 so that compressing the flask 2 towards its deformed configuration causes the cosmetic fluid to be expelled through the dispenser orifice 7 out from the flask 2 and the device 1.

Preferably, and as shown in the figures, the functional connection between the flask 2 and the dispenser orifice 7 is achieved by joining the flask 2 onto the dispenser orifice 7, i.e., by establishing fluid flow communication from the expulsion opening 2B to the dispenser orifice 7.

For this purpose, the link part 5 is advantageously provided with a connection endpiece 8 that extends between the flaps 3, 4, preferably along an axis Y-Y′. The endpiece 8 is in fluid flow communication with the dispenser orifice 7. For example, and as shown in FIGS. 4 and 5, the flask 2 is preferably plugged via its expulsion opening 2B onto the connection endpiece 8 in such a manner that the axes X-X′ and Y-Y′ are substantially parallel and preferably coincide. The assembly tab 2C comes to bear against the link part 5 and serves to stabilize the join between the flask 2 and the link part 5. Naturally, the presence of the assembly tab 2C is not absolutely essentially and is merely optional, and it is entirely possible to envisage the flask 2 presenting a bare neck that is connected to the endpiece 8.

In the exemplary embodiments shown in the figures, perfume is expelled on the well-known Venturi principle that enables the perfume to be atomized, i.e., that enables a two-phase mixture of perfume and air to be sprayed and dispersed. In order to obtain the desired atomizing effect, it is therefore necessary for the flask 2 to contain air, i.e., for the flask is not to be completely filled with the perfume (or any other substance to be sprayed). Naturally, if the dispensing is not to be in the form of an atomized spray but to be mere expulsion, it is possible for the flask 2 to be filled substantially completely with the substance that is to be dispensed.

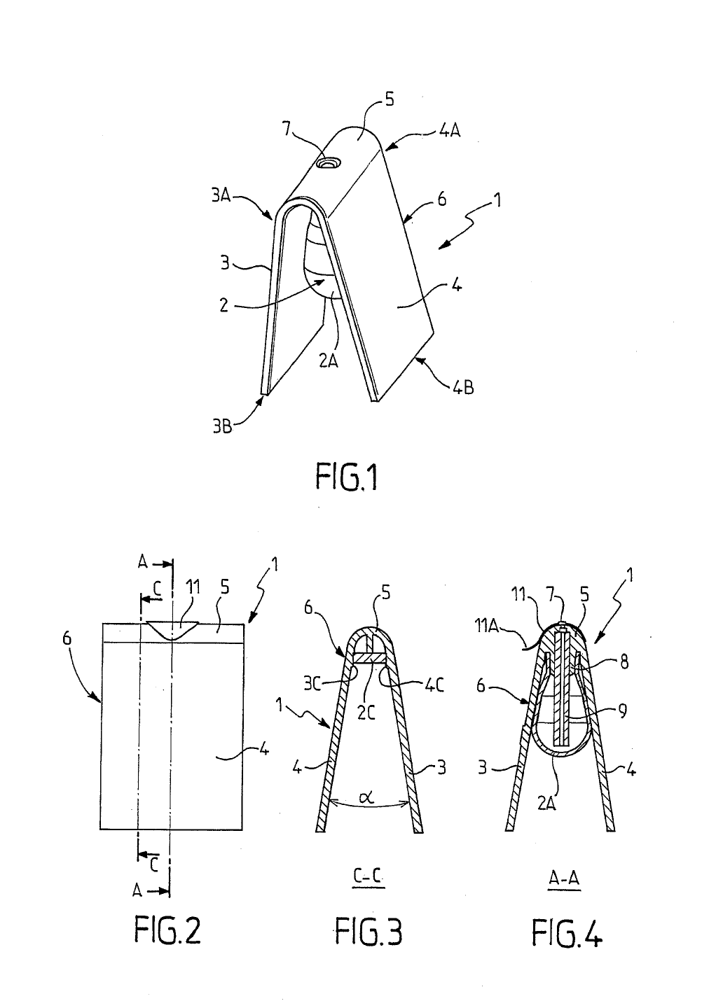

In the variant shown in FIGS. 2-4, a dip tube 9 is engaged coaxially in the endpiece 8 on its axis of symmetry Y-Y′.

The bottom end of the dip tube 9 is immersed within the perfume contained in the flask 2, while the opposite end of the dip tube 9 communicates with the outside via an orifice of smaller section, thus enabling the perfume to be atomized.

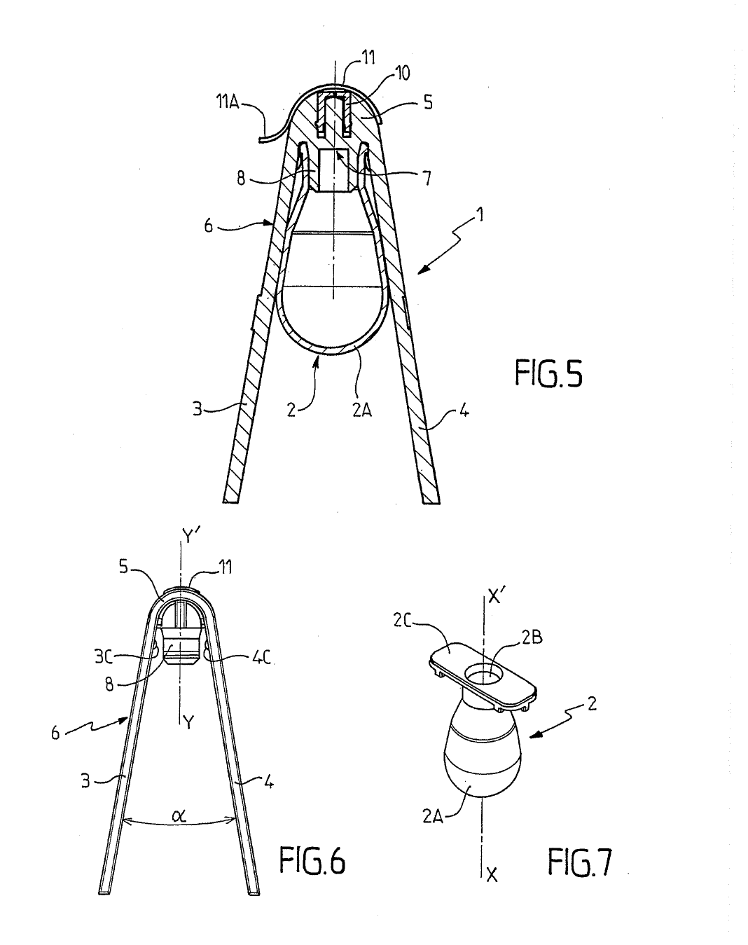

In the variant exemplary embodiment shown in FIGS. 5 and 6, the endpiece 8 does not have a dip tube, but it is in fluid flow communication with a spray nozzle 10.

In a particular exemplary embodiment, the flask 2 is inserted as a force-fit between the flaps 3, 4 so that the flaps 3, 4 continuously exert sufficient force on the flask 2 to hold it in position. In other words, even when the flaps 3, 4 are in the maximum-spread configuration, the flaps 3, 4 exert a permanent clamping force on the flask 2, which force serves to contribute essentially in full or in part only to securing the flask 2 to the V-shaped squeezer formed by the one-piece body 6. By means of this feature, it is extremely simple, quick, and inexpensive to assemble the device 1 since assembly consists merely in inserting the flask 2 between the flaps 3, 4, without it being necessary to perform any other operations, such as applying adhesive or heat-sealing, for example. Naturally, additional means may be provided for securing the flask 2 to the one-piece body 6 without going beyond the scope of the present disclosure. For example, the inside face of each flap 3, 4 could be provided with a projection 3C, 4C that projects from the first flap 3 towards the second flap 4 and vice versa, the projections 3C, 4C cooperating with the tab 2C to clip-fasten the tab 2C so that the tab is interposed between and held by the projections 3C, 4C on one side and the link part 5 on the other. Naturally, the use of such projections 3C, 4C or any other equivalent means, is entirely optional.

In the exemplary embodiments shown in the figures, the flask 2 is thus held essentially by clamping via the forces exerted by the flaps 3, 4 without it being necessary to secure the flask 2 directly to one or the other of the two flaps 3, 4. More precisely, because of the shape memory of the flask 2, there is no need to fasten the bulb 2A to the flaps 3, 4 in order to enable the flask to go from its deformed configuration to its rest configuration since the flask 2 is capable on its own of returning automatically to the rest configuration by a resilient return phenomenon. Consequently, and as shown in the figures, the flask 2 can merely bear against the flaps 3, 4 without being secured thereto. Such assembly by insertion is particularly simple and contributes to the excellent cost price of the device 1 in accordance with the present disclosure. Such assembly by inserting/clamping the flask 2 between the flaps 3, 4 is nevertheless entirely optional, and it is quite possible to envisage the flask 2 being assembled mechanically in conventional manner to the body 6, e.g., by clip-fastening the tab 2C to the body 6.

The present disclosure also provides a method of fabricating a cosmetic fluid dispenser device, in particular, a device 1 as described above.

The method of the invention in one exemplary embodiment comprises a step i) of providing or fabricating a flask 2 that is to contain the cosmetic fluid for dispensing, the flask 2 being deformable so as to be capable, on being compressed, of passing from a rest configuration in which the flask 2 presents a predetermined capacity to at least one deformed configuration in which the flask 2 presents a capacity that is smaller than that of the predetermined capacity, the flask 2 also presenting shape memory capable, when not compressed, of returning on its own from its deformed configuration to its rest configuration. Step i) preferably consists in a step of molding or blow-extruding the flask 2 out of a plastic material, which material is preferably polypropylene.

The method of the present disclosure also comprises a step ii) of fabricating or providing first and second flaps 3, 4 that are distinct from the flask 2. Preferably, in step ii) a link part 5 is also provided or fabricated, the flaps 3, 4 being attached to link part 5 such that the flaps 3, 4 and the link part 5 preferably form a single one-piece body 6. Step ii) preferably consists of molding the one-piece body 6 integrally from a plastic material, such as polyoxymethylene.

Finally, the method of the present disclosure comprises a step iii) in which the flask 2 is placed between the flaps 3, 4, which flaps are designed to be movable towards each other by the user exerting a force suitable for compressing the flask 2 in order to bring flask 2 into its deformed configuration, the assembly formed by the flaps 3, 4 likewise presenting shape memory capability, when the force ceases to be applied, of returning on its own to a configuration in which the flaps 3, 4 are spaced far enough apart from each other to cease compressing the flask 2. Preferably, in step iii), the flask 2 is inserted substantially as a force-fit between the flaps 3, 4, so that the flaps 3, 4 continuously exert sufficient force on the flask 2 to hold the flask in position.

The device 1 in accordance with the present disclosure is particularly easy to fabricate since, in preferred exemplary embodiments, the device 1 relies merely on mechanically assembling together two essential parts that are made by molding, i.e., the body 6 and the flask 2. The flask 2 and the body 6 can be assembled mechanically, for example, essentially by inserting the flask between the flaps 3, 4 until the flask 2 comes into abutment against the link part 5; the flaps 3, 4 then gripping the flask 2 in such a manner as to hold the flask 2 in position. Alternatively, mechanical assembly could be constituted merely by securing the flask 2 to the link part 5 by any known means (clip-fastening, adhesive, heat-sealing) without using clamping force from the flaps 3, 4 to hold the flask 2 in position.

Naturally, it is entirely possible to envisage the method of the present disclosure including additional steps and, for example, with the variant shown in FIGS. 2-4, a step of inserting the dip tube 9 in the endpiece 8, or with the variant of FIGS. 5 and 6, a step of installing the nozzle 10 in the link part 5, preferably by merely engaging the nozzle 10 therein.

Finally, and as shown in FIGS. 2, 4, 5, and 6, it is possible to envisage covering the orifice 7 with a removable capsule 11 that is preferably suitable for peeling off. The capsule 11 thus preferably includes a pull tongue 11A enabling the user to tear off the capsule 11 and thereby open the dispenser orifice 7, which orifice is fitted with the nozzle 10 in the variant of FIGS. 5 and 6.

The device 1 in accordance with the present disclosure operates as follows. The user begins by removing the capsule 11 in the manner described above. Thereafter, the user takes hold of the device 1 in one hand so as to be in a position to urge the flaps 3, 4 towards each other. For example, the user applies the thumb to the second flap 4 and at least one other finger to the first flap 3. The user then squeezes the flaps 3, 4 so as to cause the flaps to pivot towards each other. Under the effect of this pivoting, the flask 2 is compressed by the flaps 3, 4 and thus passes from its rest configuration in which the flask 2 was found before the user began squeezing the flaps 3, 4, to a deformed configuration in which the capacity of the flask 2 decreases. Under the effect of this sudden decrease of its capacity, a fraction of the perfume and the air contained in the flask 3 is expelled therefrom, preferably in the form of a two-phase mixture (atomization). In the exemplary embodiment shown in FIGS. 2-4, the perfume initially passes via the dip tube 9 so as to be subsequently sprayed to the outside through the dispenser orifice 7. For the exemplary embodiment shown in FIGS. 5 and 6, the perfume engages in the duct 8 so as to reach the dispenser orifice 7 fitted with the nozzle 10, through which the two-phase mixture of air and perfume is sprayed to the outside. The user can thus spray a dose of perfume in a manner that is particularly simple and accurate.

Thereafter, the user relaxes the squeezing on the flaps 3, 4 so that the flaps 3, 4 return automatically to their maximum-spread configuration by resilience, independently of the flask 2. Consecutively and independently of the movement of the flaps 3, 4, the flask 2 returns automatically to its rest configuration because of its own shape memory property. When the flask 2 goes from its deformed configuration to its rest configuration, air is sucked into the flask 2 through the dispenser orifice 7 and the connection endpiece 8. The device 1 is then ready for a new application of the spray.

1. A cosmetic fluid dispenser device, comprising:
a) a flask for containing the cosmetic fluid for dispensing, said flask being deformable so as to pass, on being compressed, from a rest configuration in which said flask presents a predetermined capacity to at least one deformed configuration in which said flask presents a capacity that is smaller than said predetermined capacity, said flask presenting shape memory so as to be capable, when not compressed, of returning on its own from its deformed configuration to its rest configuration; and
b) two flaps distinct from said flask and between which said flask is disposed, said flaps being designed to be capable of being moved towards each other under the effect of a force exerted by a user so as to compress said flask in order to bring said flask to its deformed configuration, the assembly constituted by said flaps also presenting shape memory so that when the force ceases to be applied said flask returns on its own to a configuration in which said flaps are spaced far enough apart to no longer compress said flask.

2. The device of claim 1, wherein said flaps are substantially rigid.

3. The device of claim 1, wherein said flaps are attached to each other via a link part.

4. The device of claim 3, wherein said flaps and said link part are formed from a single piece of material.

5. The device of claim 4, wherein said flaps are made integrally with said link part.

6. The device of claim 3, wherein said flaps comprise two independent one-piece unitary parts constituted respectively by said flask and by said body, said parts being assembled together. [SEE claim 16]

7. The device of claim 3, wherein said link part and said flaps are arranged substantially in a V-shape, each flap forming a respective one of the two arms of the V-shape, while said link part forms the apex of said V-shape.

8. The device of claim 3, wherein each flap is hinged resiliently to said link part.

9. The device of claim 3, further comprising a dispenser orifice formed through said link part and functionally connected to said flask so that compressing said flask towards its said deformed configuration causes cosmetic fluid to be expelled through said dispenser orifice out from said flask and said device.

10. The device of claim 1, wherein said flaps are movable towards each other by said flaps pivoting relative to said link part.

11. The device of claim 1, further comprising a perfume spray.

12. The device of claim 1, wherein the device is suitable for being held and operated by hand.

13. A method of fabricating a cosmetic fluid dispenser device, comprising:
i) providing a flask for containing the cosmetic fluid for dispensing, in which a flask is fabricated or provided that is suitable for passing, on being compressed, from a rest configuration in which said flask presents a predetermined capacity, to at least one deformed configuration in which said flask presents a capacity that is less than said predetermined capacity, said flask presenting shape memory so as to be capable, when not compressed, of returning on its own from its deformed configuration to its rest configuration;
ii) providing two connected flaps that are distinct from said flask; and
iii) placing said flask between said flaps, said flaps being designed to be movable towards each other under the effect of a user exerting a force to compress said flask so as to bring said flask into its deformed configuration, the assembly formed by said flaps also presenting shape memory so as to be capable, when the force ceases to be applied, of returning on its own to a configuration in which said flaps are spaced far enough apart to no longer compress said flask.

14. The method of claim 13, wherein in step ii) a link part is provided to which said flaps are attached, said flaps and said link part forming portions of a single one-piece body.
